(19) United States
(12) Patent Application Publication
(10) Pub. No.: US 2024/0046173 A1
(43) Pub. Date: Feb. 8, 2024

(54) MANAGEMENT SUPPORT APPARATUS, SYSTEM, VEHICLE, AND MANAGEMENT SUPPORT METHOD

(71) Applicant: TOYOTA JIDOSHA KABUSHIKI KAISHA, Toyota-shi (JP)

(72) Inventors: Chikage KUBO, Chofu-shi (JP); Kenichi YAMADA, Nisshin-shi (JP); Yuki TATSUMOTO, Seto-shi (JP); Hiromitsu FUJII, Kariya-shi (JP); Mitsuhiro NAITO, Okazaki-shi (JP)

(73) Assignee: TOYOTA JIDOSHA KABUSHIKI KAISHA, Toyota-shi (JP)

(21) Appl. No.: 18/357,589

(22) Filed: Jul. 24, 2023

(30) Foreign Application Priority Data
Aug. 5, 2022 (JP) 2022-125896

(51) Int. Cl. G06Q 10/0631

(52) U.S. Cl. CPC G06Q 10/063116

(57) ABSTRACT

A management support apparatus includes a communication interface configured to communicate with a terminal apparatus of a manager, and a controller configured to acquire, as profile data, data read from a medium held by each user when each user gets on a vehicle to be operated with multiple users on board to a factory, identify, based on the acquired profile data, that each user has already been on board, upon detecting a user who has not been on board among users scheduled to get on the vehicle, generate proposal data with reference to process data indicating a process of which the detected user is scheduled to be in charge in the factory, the proposal data proposing a schedule change for the process, and transmit the generated proposal data to the terminal apparatus of the manager via the communication interface.

### CROSS-REFERENCE TO RELATED APPLICATION

This application claims priority to Japanese Patent Application No. 2022-125896 filed on Aug. 5, 2022, the entire contents of which are incorporated herein by reference.

### TECHNICAL FIELD

The present disclosure relates to a management support apparatus, a system, a vehicle, and a management support method.

### BACKGROUND

Patent Literature (PTL) 1 discloses an attendance management system. This attendance management system includes a personal identification card reader and a management card writer that are installed on a commuter bus, and a management card reader that is installed near an entrance/exit gate of a workplace. The personal identification card reader reads personal identification information from a personal identification card of an employee. The management card writer writes the personal identification information read by the personal identification card reader to a management card. The management card reader reads the personal identification information from the management card. The management card reader outputs the read personal identification information to a management apparatus that manages attendance of employees.

### CITATION LIST

### Patent Literature

PTL 1: JP 2010-286965 A

### SUMMARY

In factories, vacancies would disrupt operations of lines.

It would be helpful to reduce disruption in operations of lines when vacancies occur in factories.

A management support apparatus according to the present disclosure includes:
a communication interface configured to communicate with a terminal apparatus of a manager; and
a controller configured to:
   acquire, as profile data, data read from a medium held by each user when each user gets on a vehicle to be operated with multiple users on board to a factory;
   identify, based on the acquired profile data, that each user has already been on board;
   upon detecting a user who has not been on board among users scheduled to get on the vehicle, generate proposal data with reference to process data indicating a process of which the detected user is scheduled to be in charge in the factory, the proposal data proposing a schedule change for the process; and
   transmit the generated proposal data to the terminal apparatus of the manager via the communication interface.

A management support method according to the present disclosure includes:
acquiring, by a controller, as profile data, data read from a medium held by each user when each user gets on a vehicle to be operated with multiple users on board to a factory;
identifying, by the controller, based on the acquired profile data, that each user has already been on board;
upon detecting a user who has not been on board among users scheduled to get on the vehicle, generating, by the controller, proposal data with reference to process data indicating a process of which the detected user is scheduled to be in charge in the factory, the proposal data proposing a schedule change for the process; and
transmitting, via a communication interface, the generated proposal data to a terminal apparatus of a manager.

According to the present disclosure, operations of lines are less likely to be disrupted even when vacancies occur in factories.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a management support apparatus according to the embodiment of the present disclosure;

FIG. 3 is a flowchart illustrating operations of the management support apparatus according to the embodiment of the present disclosure;

FIG. 4 is a flowchart illustrating operations of the management support apparatus according to the embodiment of the present disclosure;

FIG. 5 is a flowchart illustrating a specific procedure of the process in step S203 of FIG. 4; and

FIG. 6 is a flowchart illustrating a variation of the operations of the management support apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

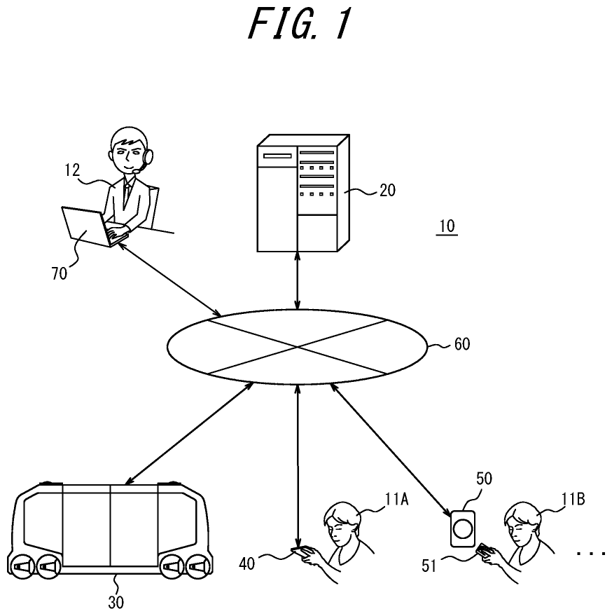

A configuration of a system 10 according to the present embodiment will be described with reference to FIG. 1.

The system 10 according to the present embodiment has a management support apparatus 20, a vehicle 30 to be operated with multiple users on board, a terminal apparatus 40 of each user, a card reader 50, and a terminal apparatus 70 of a manager 12. The management support apparatus 20 can communicate with the vehicle 30, the terminal apparatus 40 of each user, the card reader 50, and the terminal apparatus 70 of the manager 12 via a network 60. The card reader 50 can communicate with an employee identification card 51 of each user.

The management support apparatus 20 is installed in a facility such as a data center and operated by an operator managing the vehicle 30, such as a bus company. The management support apparatus 20 is a computer such as a server that belongs to a cloud computing system or another type of computing system.

The vehicle 30 is to be operated with multiple users on board to a factory. The vehicle 30 is operated as a bus, for example, an on-demand bus.

The vehicle 30 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 30, which is an AV in the present embodiment, may be driven by a driver, or the driving may be automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers. The vehicle 30 may be a MaaS-dedicated vehicle. The term “MaaS” is an abbreviation of Mobility as a Service.

The terminal apparatus 40 is held and used by each of the multiple users, such as a user 11A. The terminal apparatus 40 is, for example, a mobile device such as a mobile phone, a smartphone, or a tablet.

The card reader 50 is mounted in the vehicle 30 and is used to read data from the employee identification card 51. The card reader 50 is, for example, an IC card reader. The term “IC” is an abbreviation of integrated circuit. The employee identification card 51 is held by each of the multiple users, such as a user 11B.

The terminal apparatus 70 is installed in an operation management room and used by the manager 12. Alternatively, the terminal apparatus 70 may be held and used by the manager 12. The terminal apparatus 70 is, for example, a general purpose device such as a PC, a dedicated device, or a mobile device such as a mobile phone, a smartphone, or a tablet. The term “PC” is an abbreviation of personal computer.

The network 60 includes the Internet, at least one WAN, at least one MAN, or any combination thereof. The term “WAN” is an abbreviation of wide area network. The term “MAN” is an abbreviation of metropolitan area network. The network 60 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The management support apparatus 20 acquires, as profile data D1, data read from a medium held by each user when each user gets on the vehicle 30. The management support apparatus 20 identifies, based on the acquired profile data D1, that each user has already been on board. Upon detecting a user who has not been on board among users scheduled to get on the vehicle 30, the management support apparatus 20 generates, with reference to process data D2 indicating a process of which the detected user is scheduled to be in charge in the factory, proposal data D3 proposing a schedule change for the process. The management support apparatus 20 transmits the generated proposal data D3 to the terminal apparatus 70 of the manager 12.

In the present embodiment, it is automatically recognized, based on the data read when each user gets on the vehicle 30, that each user has already been on board. When it is detected that a user who should be on board is not on board the vehicle 30, a notification is transmitted to the manager 12. This notification includes a proposal for a schedule change for the process of which the user is scheduled to be in charge in the factory. Thus, even if a vacancy occurs in the factory, it is easier for the manager 12 to reschedule and operations of a line are less likely to be disrupted.

The schedule change includes a change of a person in charge, a change in operations, or both. When changing the person in charge, the schedule change may be proposed, taking into account the abilities or work statuses of persons already on duty. For example, an extra member, such as a supervisor who is not directly on the line, may join the line as a substitute. The substitute may be determined with reference to a skill map indicating who has what skills or a work schedule indicating who is working overtime and how much.

The user who is not on board the vehicle 30 may be contacted automatically. In other words, the notification may be transmitted not only to the manager 12, but also to the user who should be on board the vehicle 30 but is not. This notification may include details of a schedule change applied in reality, instead of the proposal for the schedule change.

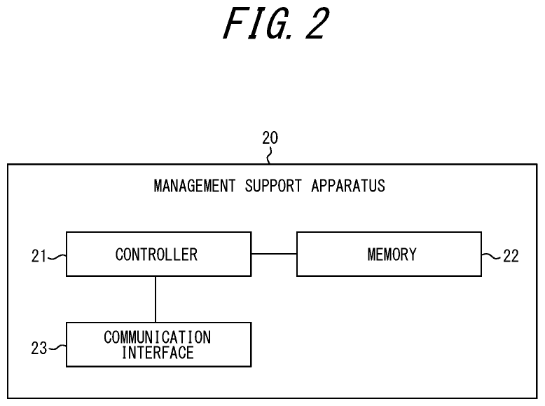

A configuration of the management support apparatus 20 according to the present embodiment will be described with reference to FIG. 2.

The management support apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the management support apparatus 20 while controlling components of the management support apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used for the operations of the management support apparatus 20 and data obtained by the operations of the management support apparatus 20.

The communication interface 23 includes at least one interface for communication. The interface for communication is, for example, an interface compatible with a wired LAN communication standard such as Ethernet ® (Ethernet is a registered trademark in Japan, other countries, or both) or a wireless LAN communication standard such as IEEE802.11. The name “IEEE” is an abbreviation of Institute of Electrical and Electronics Engineers. The communication interface 23 communicates with the vehicle 30, the terminal apparatus 40 of each user, the card reader 50, and the terminal apparatus 70 of the manager 12. The communication interface 23 receives data to be used for the operations of the management support apparatus 20, and transmits data obtained by the operations of the management support apparatus 20.

The functions of the management support apparatus 20 are realized by execution of a program according to the present embodiment by a processor serving as the controller 21. That is, the functions of the management support apparatus 20 are realized by software. The program causes a computer to execute the operations of the management support apparatus 20, thereby causing the computer to function as the management support apparatus 20. That is, the computer executes the operations of the management support apparatus 20 in accordance with the program to thereby function as the management support apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the management support apparatus 20 may be realized by a programmable circuit or a dedicated circuit serving as the controller 21. That is, some or all of the functions of the management support apparatus 20 may be realized by hardware.

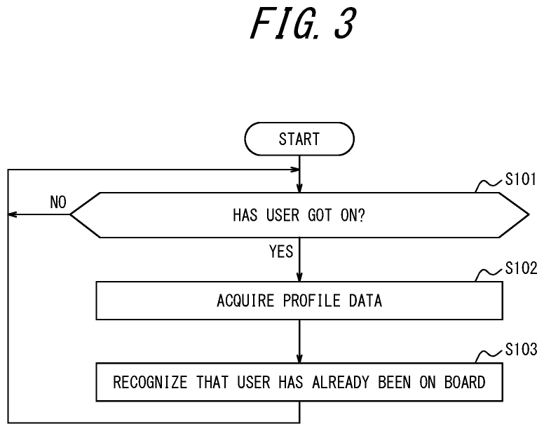

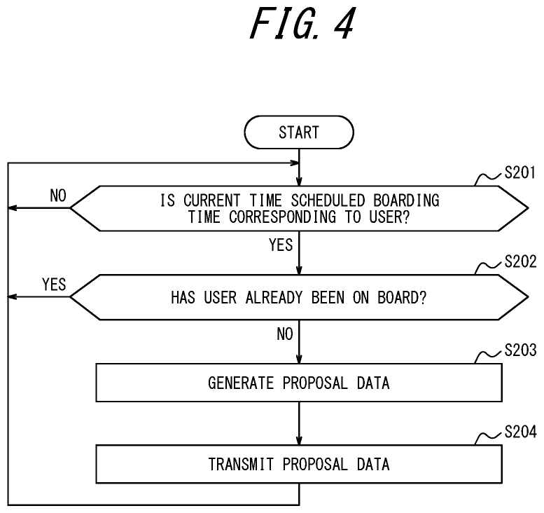

Operations of the management support apparatus 20 according to the present embodiment will be described with reference to FIGS. 3 and 4. The operations illustrated in FIGS. 3 and 4 correspond to a management support method according to the present embodiment.

Operations illustrated in FIG. 3 will be described.

In step S101, the controller 21 of the management support apparatus 20 determines whether a user has got on the vehicle 30. Specifically, the controller 21 determines that the user 11A has got on the vehicle 30 upon being notified by the vehicle 30 or the terminal apparatus 40 via the communication interface 23 that short-range wireless communication has taken place between the terminal apparatus 40 and a receiver, which is installed in the vehicle 30 and compatible with a short-range wireless communication standard such as Bluetooth ® (Bluetooth is a registered trademark in Japan, other countries, or both). The controller 21 determines that the user 11B has got on the vehicle 30 upon being notified by the vehicle 30 or the card reader 50 via the communication interface 23 that the employee identification card 51 has been held over the card reader 50.

The controller 21 of the management support apparatus 20 may determine that the user 11A has got on the vehicle 30 upon receiving the fact that the position of the terminal apparatus 40 matches the position of the vehicle 30, even without notification from the vehicle 30 or the terminal apparatus 40. In such a variation, the controller 21 receives, from the vehicle 30 via the communication interface 23, a positioning result obtained by a GNSS receiver mounted on the vehicle 30. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite

System. The term “GLONASS” is an abbreviation of Global Navigation Satellite System. The controller 21 receives, from the terminal apparatus 40 via the communication interface 23, a positioning result obtained by a GNSS receiver mounted on the terminal apparatus 40. The controller 21 compares the position of the terminal apparatus 40 indicated by the positioning result received from the terminal apparatus 40 with the position of the vehicle 30 indicated by the positioning result received from the vehicle 30. The controller 21 determines that the user 11A has got on the vehicle 30 in a case in which the position of the terminal apparatus 40 matches the position of the vehicle 30. The controller 21 determines that the user 11A has not got on the vehicle 30 in a case in which the position of the terminal apparatus 40 does not match the position of the vehicle 30.

In a case in which it is determined in step S101 that the user has not got on the vehicle 30, i.e., the user's boarding on the vehicle 30 is not detected, the process in step S101 is performed again. In a case in which it is determined in step S101 that the user has got on the vehicle 30, i.e., the user's boarding on the vehicle 30 is detected, the process in step S102 is performed.

In step S102, the controller 21 of the management support apparatus 20 acquires, as profile data D1, data read from a medium held by the user when the user gets on the vehicle 30. Specifically, the controller 21 acquires profile data D1A on the user 11A by receiving, from the vehicle 30 via the communication interface 23, data received from the terminal apparatus 40 when the short-range wireless communication is performed between the terminal apparatus 40 and the receiver mounted in the vehicle 30. The controller 21 acquires profile data D1B on the user 11B by receiving, from the vehicle 30 or the card reader 50 via the communication interface 23, data read from the employee identification card 51 when the employee identification card 51 is held over the card reader 50.

In the present embodiment, the controller 21 of the management support apparatus 20 acquires, as the profile data D1, identification data that uniquely identifies each user. In other words, the controller 21 acquires, as the profile data D1A, identification data that identifies the user 11A. The controller 21 acquires, as the profile data D1B, identification data that identifies the user 11B.

In step S103, the controller 21 of the management support apparatus 20 recognizes, based on the profile data D1 acquired in step S102, that the user has already been on board. Specifically, the controller 21 stores, in the memory 22, confirmation data D4 indicating that the user identified by the profile data D1 has already been on board. In other words, in a case in which the profile data D1A is acquired in step S102, the controller 21 stores, in the memory 22, confirmation data D4A indicating that the user 11A has already been on board. In a case in which the profile data D1B is acquired in step S102, the controller 21 stores, in the memory 22, confirmation data D4B indicating that the user 11B has already been on board. The controller 21 may store the profile data D1 as is in the memory 22 as the confirmation data D4.

The process in step S101 is executed again after the process in step S103.

Operations illustrated in FIG. 4 will be described. The operations illustrated in FIG. 4 may be performed in parallel with those illustrated in FIG. 3.

In step S201, the controller 21 of the management support apparatus 20 determines, with reference to time data D5 indicating a scheduled boarding time for each of users scheduled to get on the vehicle 30, whether a current time is a scheduled boarding time corresponding to one of the users scheduled to get on the vehicle 30. The time data D5 is stored in advance in the memory 22 of the management support apparatus 20. Alternatively, the time data D5 may be stored in an external storage to which the communication interface 23 of the management support apparatus 20 can be connected.

In a case in which it is determined in step S201 that the current time is not the scheduled boarding time corresponding to one of the users scheduled to get on the vehicle 30, the process in step S201 is executed again. When one of the users scheduled to get on the vehicle 30 is designated as a user X, and in a case in which it is determined in step S201 that the current time is a scheduled boarding time corresponding to the user X, the process in step S202 is executed.

In step S202, the controller 21 of the management support apparatus 20 determines whether the user X has already been on board the vehicle 30. Specifically, the controller 21 determines whether it is recognized by the corresponding scheduled boarding time that the user X has already been on board, depending on whether data indicating that the user X has already been on board is stored in the memory 22 as the confirmation data D4. That is, in a case in which the user 11A is included in the users scheduled to get on the vehicle 30 and it is determined in step S201 that the current time is a scheduled boarding time corresponding to the user 11A, the controller 21 determines whether it is recognized by the corresponding scheduled boarding time that the user 11A has already been on board, depending on whether the confirmation data D4A is stored in the memory 22. In a case in which the confirmation data D4A is not stored in the memory 22, the controller 21 does not recognize by the corresponding scheduled boarding time that the user 11A has already been on board. Therefore, the controller 21 detects the user 11A, among the users scheduled to get on the vehicle 30, as a user who has not been on board. In a case in which the user 11B is included in the users scheduled to get on the vehicle 30 and it is determined in step S201 that the current time is a scheduled boarding time corresponding to the user 11B, the controller 21 determines whether it is recognized by the corresponding scheduled boarding time that the user 11B has already been on board, depending on whether the confirmation data D4B is stored in the memory 22. In a case in which the confirmation data D4B is not stored in the memory 22, the controller 21 does not recognize by the corresponding scheduled boarding time that the user 11B has already been on board. Therefore, the controller 21 detects the user 11B, among the users scheduled to get on the vehicle 30, as a user who has not been on board.

In a case in which it is determined in step S202 that the user X has already been on board the vehicle 30, i.e., the user X is not detected as a user who has not been on board, the process in step S201 is performed again. In a case in which it is determined in step S202 that the user X has not been on board the vehicle 30, i.e., the user X is detected as a user who has not been on board, the process in step S203 is performed.

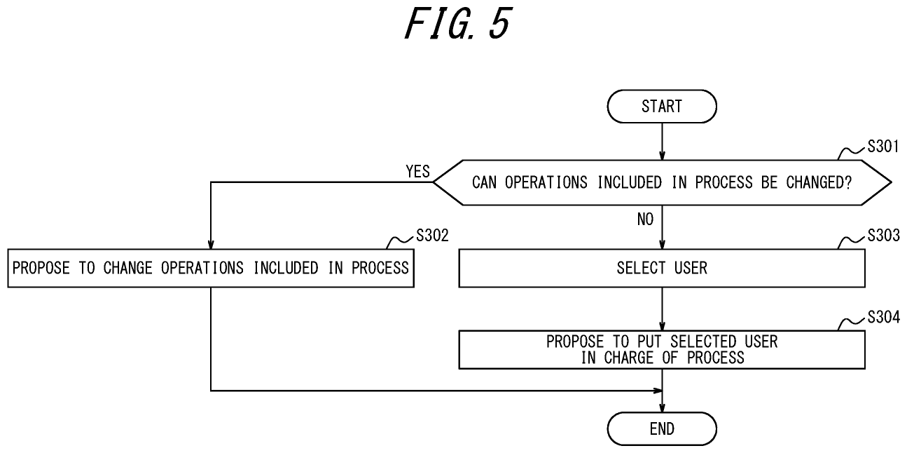

In step S203, the controller 21 of the management support apparatus 20 generates, with reference to process data D2 indicating a process of which the user X, i.e., the user detected in step S202, is scheduled to be in charge in the factory, proposal data D3 proposing a schedule change for the process. FIG. 5 illustrates a specific procedure.

In step S301 of FIG. 5, the controller 21 of the management support apparatus 20 determines whether operations included in the process indicated by the process data D2 can be changed. The process data D2 is stored in advance in the memory 22 of the management support apparatus 20. Alternatively, the process data D2 may be stored in an external storage to which the communication interface 23 of the management support apparatus 20 can be connected. For example, the controller 21 determines, with reference to information such as the type or importance of operations included in the process data D2, whether the operation can be omitted.

In a case in which it is determined in step S301 of FIG. 5 that the operations can be changed, the process in step S302 of FIG. 5 is executed. In a case in which it is determined in step S301 of FIG. 5 that the operations cannot be changed, the process in step S303 of FIG. 5 is executed.

In step S302 of FIG. 5, the controller 21 of the management support apparatus 20 includes, in the proposal data D3, data proposing to change the operations included in the process indicated by the process data D2. For example, the controller 21 generates, as the proposal data D3, data proposing to omit one or more operations.

In step S303 of FIG. 5, the controller 21 of the management support apparatus 20 selects, with reference to ability data D6 indicating ability for each of the users scheduled to get on the vehicle 30, work status data D7 indicating a work status for each of the users scheduled to get on the vehicle 30 or both, a user to be in charge of the process indicated by the process data D2, instead of the user X, from among the users scheduled to get on the vehicle 30. The ability data D6 and work status data D7 are stored in advance in the memory 22 of the management support apparatus 20. Alternatively, the ability data D6 and work status data D7 may be stored in an external storage to which the communication interface 23 of the management support apparatus 20 can be connected. For example, the controller 21 selects, with reference to information such as a skill map included in the ability data D6, a user who can be in charge of the operations included in the process indicated by the process data D2 as a substitute. Alternatively, the controller 21 may select, with reference to information such as a work schedule included in the work status data D7, a user with fewer overtime hours as a substitute.

Instead of selecting a different user from the user X among the users scheduled to get on the vehicle 30, the controller 21 of the management support apparatus 20 may select a different user from the users scheduled to get on the vehicle 30. In such a variation, the ability data D6 is data indicating ability for each of different users from the users scheduled to get on the vehicle 30. The work status data D7 is data indicating a work status for each of different users from the users scheduled to get on the vehicle 30.

In step S304 of FIG. 5, the controller 21 of the management support apparatus 20 includes, in the proposal data D3, data proposing to put the user selected in step S303 of FIG. 5 in charge of the process indicated by the process data D2. For example, the controller 21 generates, as the proposal data D3, data proposing to put one or more substitutes in charge of the operations.

In step S204, the controller 21 of the management support apparatus 20 transmits, via the communication interface 23, the proposal data D3 generated in step S203 to the terminal apparatus 70 of the manager 12. The terminal apparatus 70 of the manager 12 receives the proposal data D3 from the management support apparatus 20 via an interface, which is implemented in the terminal apparatus 70 and compatible with a wired LAN communication standard such as Ethernet®, a wireless LAN communication standard such as IEEE802.11, or a mobile communication standard such as LTE, 4G standard, or 5G standard. The term “LTE” is an abbreviation of Long Term Evolution. The term “4G” is an abbreviation of 4th generation. The term “5G” is an abbreviation of 5th generation. The terminal apparatus 70 displays the received proposal data D3 on a display, such as an LCD or organic EL, mounted on or connected to the terminal apparatus 70. The term “LCD” is an abbreviation of liquid crystal display. The term “EL” is an abbreviation of electro luminescent. Alternatively, the terminal apparatus 70 may output the received proposal data D3 in audio from a speaker mounted on or connected to the terminal apparatus 70. The manager 12 can change, with reference to the contents of the proposal data D3 output via display or audio, a schedule for the process of which the user X is scheduled to be in charge in the factory. Therefore, operations of the line are less likely to be disrupted.

The controller 21 of the management support apparatus 20 may not only transmit the proposal data D3 to the terminal apparatus 70 of the manager 12, but may also transmit notification data D8 to the terminal apparatus 40 of the user X via the communication interface 23. In such a variation, the notification data D8 may be data simply cautioning the user X about not being on board the vehicle 30, or data notifying the user X, after the schedule change proposed in the proposal data D3 or another schedule change is applied, of the details of the schedule change actually applied. The terminal apparatus 40 of the user X receives the notification data D8 from the management support apparatus 20 via an interface, which is implemented in the terminal apparatus 40 and compatible with a mobile communication standard such as LTE, 4G standard, or 5G standard, or a wireless LAN communication standard such as IEEE802.11. The terminal apparatus 40 displays the received notification data D8 on a display, such as an LCD or organic EL, mounted on the terminal apparatus 40. Alternatively, the terminal apparatus 40 may output the received notification data D8 in audio from a speaker mounted on the terminal apparatus 40.

The process in step S201 is executed again after the process in step S204.

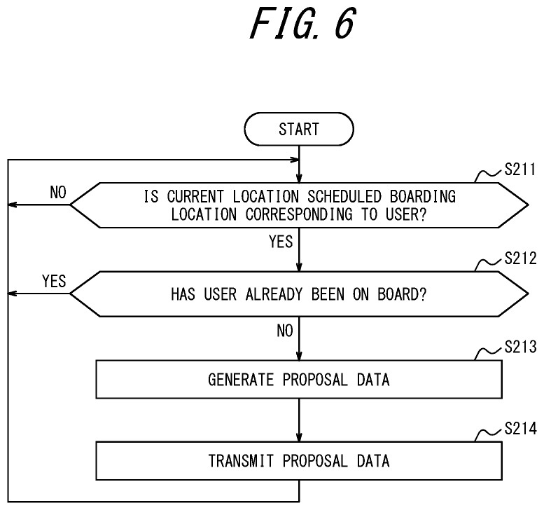

A variation of the operations illustrated in FIG. 4 will be described with reference to FIG. 6.

In step S211, the controller 21 of the management support apparatus 20 determines, with reference to location data D9 indicating a scheduled boarding location for each of the users scheduled to get on the vehicle 30, whether a current location of the vehicle 30 is a scheduled boarding location corresponding to one of the users scheduled to get on the vehicle 30. The location data D9 is stored in advance in the memory 22 of the management support apparatus 20. Alternatively, the location data D9 may be stored in an external storage to which the communication interface 23 of the management support apparatus 20 can be connected. Any method may be used to identify the current location of the vehicle 30. For example, a positioning result obtained by a GNSS receiver mounted on the vehicle 30 may be received from the vehicle 30.

In a case in which it is determined in step S211 that the current location is not the scheduled boarding location corresponding to one of the users scheduled to get on the vehicle 30, the process in step S211 is executed again. When one of the users scheduled to get on the vehicle 30 is designated as a user X, and in a case in which it is determined in step S211 that the current location is a scheduled boarding location corresponding to the user X, the process in step S212 is executed.

In step S212, the controller 21 of the management support apparatus 20 determines whether the user X has already been on board the vehicle 30. Specifically, the controller 21 determines whether it is recognized at the corresponding scheduled boarding location that the user X has already been on board, depending on whether data indicating that the user X has already been on board is stored in the memory 22 as the confirmation data D4. That is, in a case in which the user 11A is included in the users scheduled to get on the vehicle 30 and it is determined in step S211 that the current location is a scheduled boarding location corresponding to the user 11A, the controller 21 determines whether it is recognized at the corresponding scheduled boarding location that the user 11A has already been on board, depending on whether the confirmation data D4A is stored in the memory 22. In a case in which the confirmation data D4A is not stored in the memory 22, the controller 21 does not recognize at the corresponding scheduled boarding location that the user 11A has already been on board. Therefore, the controller 21 detects the user 11A, among the users scheduled to get on the vehicle 30, as a user who has not been on board. In a case in which the user 11B is included in the users scheduled to get on the vehicle 30 and it is determined in step S211 that the current location is a scheduled boarding location corresponding to the user 11B, the controller 21 determines whether it is recognized at the corresponding scheduled boarding location that the user 11B has already been on board, depending on whether the confirmation data D4B is stored in the memory 22. In a case in which the confirmation data D4B is not stored in the memory 22, the controller 21 does not recognize at the corresponding scheduled boarding location that the user 11B has already been on board. Therefore, the controller 21 detects the user 11B, among the users scheduled to get on the vehicle 30, as a user who has not been on board.

In a case in which it is determined in step S212 that the user X has already been on board the vehicle 30, i.e., the user X is not detected as a user who has not been on board, the process in step S211 is performed again. In a case in which it is determined in step S212 that the user X has not been on board the vehicle 30, i.e., the user X is detected as a user who has not been on board, the process in step S213 is performed.

The processes in steps S213 and S214 are the same as the processes in steps S203 and S204 of FIG. 4, respectively, and thus descriptions thereof are omitted.

As a variation of the present embodiment, the management support apparatus 20 may be provided in the vehicle 30.

Examples of some embodiments of the present disclosure are described below. However, it should be noted that the embodiments of the present disclosure are not limited to these examples.

[Appendix 1] A management support apparatus comprising:
a communication interface configured to communicate with a terminal apparatus of a manager; and
a controller configured to:
   acquire, as profile data, data read from a medium held by each user when each user gets on a vehicle to be operated with multiple users on board to a factory;
   identify, based on the acquired profile data, that each user has already been on board;
   upon detecting a user who has not been on board among users scheduled to get on the vehicle, generate proposal data with reference to process data indicating a process of which the detected user is scheduled to be in charge in the factory, the proposal data proposing a schedule change for the process; and
   transmit the generated proposal data to the terminal apparatus of the manager via the communication interface.
      [Appendix 2] The management support apparatus according to appendix 1, wherein the controller is configured to detect, with reference to time data indicating a scheduled boarding time for each of the users scheduled to get on the vehicle, a user who is not recognized to have already been on board by a corresponding scheduled boarding time, as a user who has not been on board.
      [Appendix 3] The management support apparatus according to appendix 1 or 2, wherein the controller is configured to detect, with reference to location data indicating a scheduled boarding location for each of the users scheduled to get on the vehicle, a user who is not recognized to have already been on board at a corresponding scheduled boarding location, as a user who has not been on board.
      [Appendix 4] The management support apparatus according to any one of appendices 1 to 3, wherein the controller is configured to include, in the proposal data, data proposing to change an operation included in the process indicated by the process data.
      [Appendix 5] The management support apparatus according to any one of appendices 1 to 4, wherein the controller is configured to include, in the proposal data, data proposing to put a different user from the detected user, among the users scheduled to get on the vehicle, in charge of the process indicated by the process data.
      [Appendix 6] The management support apparatus according to appendix 5, wherein the controller is configured to select, with reference to ability data indicating ability for each of the users scheduled to get on the vehicle, a user to be in charge of the process indicated by the process data, from among the users scheduled to get on the vehicle.
      [Appendix 7] The management support apparatus according to appendix 5 or 6, wherein the controller is configured to select, with reference to work status data indicating a work status for each of the users scheduled to get on the vehicle, a user to be in charge of the process indicated by the process data, from among the users scheduled to get on the vehicle.
      [Appendix 8] The management support apparatus according to any one of appendices 1 to 4, wherein the controller is configured to include, in the proposal data, data proposing to put a different user from the users scheduled to get on the vehicle in charge of the process indicated by the process data.
      [Appendix 9] The management support apparatus according to appendix 8, wherein the controller is configured to select, with reference to ability data indicating ability for each of different users from the users scheduled to get on the vehicle, a user to be in charge of the process indicated by the process data, from among the different users.
      [Appendix 10] The management support apparatus according to appendix 8 or 9, wherein the controller is configured to select, with reference to work status data indicating a work status for each of different users from the users scheduled to get on the vehicle, a user to be in charge of the process indicated by the process data, from among the different users.
      [Appendix 11] The management support apparatus according to any one of appendices 1 to 10, wherein
the communication interface is configured to further communicate with a terminal apparatus of each user, and
the controller is configured to, upon detecting a user who has not been on board, transmit notification data to a terminal apparatus of the detected user via the communication interface.
   [Appendix 12] The management support apparatus according to any one of appendices 1 to 11, wherein the medium is an employee identification card of each user.
   [Appendix 13] A system comprising:
the management support apparatus according to any one of appendices 1 to 12; and
the terminal apparatus of the manager.
   [Appendix 14] A vehicle comprising the management support apparatus according to any one of appendices 1 to 12.
   [Appendix 15] A management support method comprising:
acquiring, by a controller, as profile data, data read from a medium held by each user when each user gets on a vehicle to be operated with multiple users on board to a factory;
identifying, by the controller, based on the acquired profile data, that each user has already been on board;
upon detecting a user who has not been on board among users scheduled to get on the vehicle, generating, by the controller, proposal data with reference to process data indicating a process of which the detected user is scheduled to be in charge in the factory, the proposal data proposing a schedule change for the process; and
transmitting, via a communication interface, the generated proposal data to a terminal apparatus of a manager.
   [Appendix 16] The management support method according to appendix 15, wherein the generating comprises detecting, with reference to time data indicating a scheduled boarding time for each of the users scheduled to get on the vehicle, a user who is not recognized to have already been on board by a corresponding scheduled boarding time, as a user who has not been on board.
   [Appendix 17] The management support method according to appendix 15 or 16, wherein the generating comprises detecting, with reference to location data indicating a scheduled boarding location for each of the users scheduled to get on the vehicle, a user who is not recognized to have already been on board at a corresponding scheduled boarding location, as a user who has not been on board.
   [Appendix 18] The management support method according to any one of appendices 15 to 17, wherein the proposal data includes data proposing to change an operation included in the process indicated by the process data.
   [Appendix 19] The management support method according to any one of appendices 15 to 18, wherein the proposal data includes data proposing to put a different user from the detected user, among the users scheduled to get on the vehicle, in charge of the process indicated by the process data.
   [Appendix 20] The management support method according to any one of appendices 15 to 18, wherein the proposal data includes data proposing to put a different user from the users scheduled to get on the vehicle in charge of the process indicated by the process data.

The present disclosure is not limited to the embodiment described above. For example, two or more blocks described in the block diagram may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A management support apparatus comprising:
a communication interface configured to communicate with a terminal apparatus of a manager; and
a controller configured to:
acquire, as profile data, data read from a medium held by each user when each user gets on a vehicle to be operated with multiple users on board to a factory;
identify, based on the acquired profile data, that each user has already been on board;
upon detecting a user who has not been on board among users scheduled to get on the vehicle, generate proposal data with reference to process data indicating a process of which the detected user is scheduled to be in charge in the factory, the proposal data proposing a schedule change for the process; and
transmit the generated proposal data to the terminal apparatus of the manager via the communication interface.

2. The management support apparatus according to claim 1, wherein the controller is configured to detect, with reference to time data indicating a scheduled boarding time for each of the users scheduled to get on the vehicle, a user who is not recognized to have already been on board by a corresponding scheduled boarding time, as a user who has not been on board.

3. The management support apparatus according to claim 1, wherein the controller is configured to detect, with reference to location data indicating a scheduled boarding location for each of the users scheduled to get on the vehicle, a user who is not recognized to have already been on board at a corresponding scheduled boarding location, as a user who has not been on board.

4. The management support apparatus according to claim 1, wherein the controller is configured to include, in the proposal data, data proposing to change an operation included in the process indicated by the process data.

5. The management support apparatus according to claim 1, wherein the controller is configured to include, in the proposal data, data proposing to put a different user from the detected user, among the users scheduled to get on the vehicle, in charge of the process indicated by the process data.

6. The management support apparatus according to claim 5, wherein the controller is configured to select, with reference to ability data indicating ability for each of the users scheduled to get on the vehicle, a user to be in charge of the process indicated by the process data, from among the users scheduled to get on the vehicle.

7. The management support apparatus according to claim 5, wherein the controller is configured to select, with reference to work status data indicating a work status for each of the users scheduled to get on the vehicle, a user to be in charge of the process indicated by the process data, from among the users scheduled to get on the vehicle.

8. The management support apparatus according to claim 1, wherein the controller is configured to include, in the proposal data, data proposing to put a different user from the users scheduled to get on the vehicle in charge of the process indicated by the process data.

9. The management support apparatus according to claim 8, wherein the controller is configured to select, with reference to ability data indicating ability for each of different users from the users scheduled to get on the vehicle, a user to be in charge of the process indicated by the process data, from among the different users.

10. The management support apparatus according to claim 8, wherein the controller is configured to select, with reference to work status data indicating a work status for each of different users from the users scheduled to get on the vehicle, a user to be in charge of the process indicated by the process data, from among the different users.

11. The management support apparatus according to claim 1, wherein
the communication interface is configured to further communicate with a terminal apparatus of each user, and
the controller is configured to, upon detecting a user who has not been on board, transmit notification data to a terminal apparatus of the detected user via the communication interface.

12. The management support apparatus according to claim 1, wherein the medium is an employee identification card of each user.

13. A system comprising:
the management support apparatus according to claim 1; and
the terminal apparatus of the manager.

14. A vehicle comprising the management support apparatus according to claim 1.

15. A management support method comprising:
acquiring, by a controller, as profile data, data read from a medium held by each user when each user gets on a vehicle to be operated with multiple users on board to a factory;
identifying, by the controller, based on the acquired profile data, that each user has already been on board;
upon detecting a user who has not been on board among users scheduled to get on the vehicle, generating, by the controller, proposal data with reference to process data indicating a process of which the detected user is scheduled to be in charge in the factory, the proposal data proposing a schedule change for the process; and
transmitting, via a communication interface, the generated proposal data to a terminal apparatus of a manager.

16. The management support method according to claim 15, wherein the generating comprises detecting, with reference to time data indicating a scheduled boarding time for each of the users scheduled to get on the vehicle, a user who is not recognized to have already been on board by a corresponding scheduled boarding time, as a user who has not been on board.

17. The management support method according to claim 15, wherein the generating comprises detecting, with reference to location data indicating a scheduled boarding location for each of the users scheduled to get on the vehicle, a user who is not recognized to have already been on board at a corresponding scheduled boarding location, as a user who has not been on board.

18. The management support method according to claim 15, wherein the proposal data includes data proposing to change an operation included in the process indicated by the process data.

19. The management support method according to claim 15, wherein the proposal data includes data proposing to put a different user from the detected user, among the users scheduled to get on the vehicle, in charge of the process indicated by the process data.

20. The management support method according to claim 15, wherein the proposal data includes data proposing to put a different user from the users scheduled to get on the vehicle in charge of the process indicated by the process data.
